(19) United States
(12) Patent Application Publication
(10) Pub. No.: US 2015/0052157 A1
(43) Pub. Date: Feb. 19, 2015

(54) DATA TRANSFER CONTENT SELECTION

(71) Applicant: International Business Machines Corporation, Armonk, NY (US)

(72) Inventor: Timothy J. Thompson, St. Thomas (CA)

(73) Assignee: International Business Machines Corporation, Armonk, NY (US)

(21) Appl. No.: 13/965,601

(22) Filed: Aug. 13, 2013

(51) Int. Cl. G06F 17/30

(52) U.S. Cl. CPC G06F 17/30569; G06F 17/30699
USPC 707/754

(57) ABSTRACT

The present disclosure includes a method for transferring data from a source database configured with a first, hierarchical data structure to a destination database configured with a second, different data structure. Data from the source database can be parsed according to a plurality of source fields that define a portion of the hierarchical data structure. Content values stored in the source database for one or more subfields of the plurality of source fields can be accessed. A user interface can display the content values in a selectable format. A filter can be generated from selected content values. The data from the source database can be filtered using the filter. The data from the source database can be transformed according to the second, different structure of the destination database. The filter and transformed data can be loaded from the source database to the destination database.

### FIELD

This disclosure relates to data transfers between different systems, databases and applications. In particular, it relates to selection capabilities for transferring data between systems, databases and applications.

### BACKGROUND

Database management systems can be designed to accommodate the storage and management of large amounts of data. Enterprise applications can create, manage and otherwise use, the large amounts of data. Companies can sometimes accumulate multiple different applications, e.g., for supporting different business units within the companies. This allows for tailoring of each application to serve the specific needs of each business unit. Often, however, it is desirable for the applications to share data, and the amount of data to be shared can be significant. Transferring data to allow this sharing can consume significant resources, whether in time, computer processing costs, storage requirements or otherwise.

### SUMMARY

Aspects of the present disclosure are directed to dynamic control over data transfers between multiple databases, and methods of using, that address challenges including those discussed herein, and that are applicable to a variety of applications. These and other aspects of the present invention are exemplified in a number of implementations and applications, some of which are shown in the figures and characterized in the claims section that follows.

Various embodiments of the present disclosure are directed toward defining and applying dynamic staging of (extract, transform, and load (ETL)) data for content selection based on data entity relationships. This can facilitate loading of the destination database by excluding data based upon the required business content relative to the destination database and its use. For instance, an algorithm can be applied that defines a data-relationship for source-stage data content and hierarchical XML interpretation. The algorithm can use a flexible, possibly distributed, staging area for interactive display/selection of data. Content filtering can be made based on selections made by individuals. These aspects can be carried out within the (ETL) data transfer process.

In certain embodiments of the disclosure, a computer-implemented method is provided for transferring data from a source database configured with a first, hierarchical data structure to a destination database configured with a second, different data structure. The method includes parsing data from the source database according to a plurality of source fields that define a portion of the hierarchical data structure. The computer can access content values stored in the source database for one or more subfields of the plurality of source fields. A user interface is generated that displays the content values in a selectable format. A filter is created that is responsive to a selection of one or more of the content values displayed by the user interface. The data from the source database is filtered using the filter. The data from the source database is transformed according to the second, different structure of the destination database. The filtered and transformed data is loaded from the source database to the destination database.

According to certain embodiments, a device includes a computer system. The computer system is designed to transfer data from a source database configured with a first, hierarchical data structure to a destination database configured with a second, different data structure. The computer system includes a parsing module that is configured to parse data from the source database according to a plurality of source fields that define a portion of the hierarchical data structure, access content values stored in the source database for one or more subfields of the plurality of source fields, and generate a user interface that displays the content values in a selectable format. A filter module is configured to create a filter that is responsive to a selection of one or more of the content values displayed by the user interface, and to apply a filter module to filter the data from the source database using the filter. A transfer tool is configured to transform the data from the source database according to the second, different structure of the destination database, and to load the filter and transformed data from the source database to the destination database.

Embodiments are directed towards, computer program product for transferring data from a source database configured with a first, hierarchical data structure to a destination database configured with a second, different data structure. The computer program product having a computer readable storage medium having program code embodied therewith, the program code readable/executable by a computer processor to perform a method that includes parsing data from the source database according to a plurality of source fields that define a portion of the hierarchical data structure. The computer can access content values stored in the source database for one or more subfields of the plurality of source fields. A user interface is generated that displays the content values in a selectable format. A filter is created that is responsive to a selection of one or more of the content values displayed by the user interface. The data from the source database is filtered using the filter. The data from the source database is transformed according to the second, different structure of the destination database. The filtered and transformed data is loaded from the source database to the destination database.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments of the invention and do not limit the disclosure.

FIG. 1 depicts a system diagram of modules useful in data transfer operations, consistent with embodiments of the present disclosure;

FIG. 2 depicts a flow diagram for transferring data between source and destination databases using dynamically constructed filters, consistent with embodiments of the present disclosure;

FIG. 3 depicts a flow diagram for a staging area and the configuration and display of content from a source database, consistent with embodiments of the present disclosure;

FIG. 4 depicts a flow diagram for carrying out a data transfer with dynamic selection of data content, consistent with embodiments of the present disclosure; and

FIG. 5 depicts a high-level block diagram of an exemplary computer system 500 for implementing various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to managing data transfers between different databases, more particular aspects relate to the use of data filters developed from user input. While the present invention is not necessarily limited to such applications, various aspects of the invention may be appreciated through a discussion of various examples using this context.

Embodiments of the present disclosure are directed toward transferring data between source and destination databases using a dynamically adjustable filtering solution. In various embodiments, the filtering can be adjusted by presenting one or more individuals with data values that have been populated from the source database. The individuals can then view and select data values to be transferred while excluding those data values that are not needed for the particular transfer.

Particular embodiments deal with source databases that use a hierarchical structure to store the data contained therein. A transferring system can be designed to automatically parse the data using relatively high level structures. For instance, the high level structures or parent elements may be relatively consistent and known to a designer of the transferring system, which facilitates the automation of parsing at this (parent) level. A first level of filtering can be carried out at this level, but various embodiments do not necessarily use such filtering. The lower level structures, or child elements, can be presented to one or more individuals along with indications of their relationship to the parent level and/or each other. The individuals can then view the values, their descriptions and their relationships. This information can then be used to select which data to transfer and which data not to transfer.

Consistent with embodiments of the present disclosure, one or more individuals are presented with filter selection options during an extract, transform, and load (ETL) process. This three-stage ETL process can be used to integrated and/or analyze data stored in different databases substantially independently from their respective and different database structures or formats. The extraction step can include collection of data from one or more data sources. The transformation step can include reformatting of the data to conform to the destination database structure. The transformed data can then be loaded into the destination database (or data warehouse) for subsequent use and analysis. For instance, ETL tools can be used to move data between two different operational systems (e.g., as part of a software upgrade or change).

Consistent with embodiments of the present disclosure, it is recognized that an ETL tool designer or programmer may not have a full working knowledge of the data being processed. This can be particularly true when the source data can dynamically change or when the data is particularly voluminous in quantity and type. Moreover, the ETL tool may be reused in the future and the content and structure of the source database may change between uses. Aspects of the present disclosure allow for dynamic selection of data from the source database in order to reduce the amount of data processed. This selection can occur during the ETL process and can be carried out by one or more knowledgeable individuals by presenting a user interface that allows for the selection of particular data content values. These content values can be extracted from the source database during the ETL process.

Embodiments of the present disclosure are directed toward the use of filters to reduce the amount of data processed by an ETL (or similar) transfer processes. For instance, some ETL tools can be designed to collect and consolidate data obtained from several different sources. This can not only increase the complexity of the ETL process, but can also make it difficult to optimize the ETL tool for the ETL process. The use of intelligently selected data filters can reduce the amount of data that is processed in one or more of the ETL stages.

Consistent with certain embodiments, the extraction step can include a conversion step that changes the data into a format used for the transformation step. The complexity of the extraction process may vary based upon the source data. For instance, the source database can include redundant data or data that is not relevant to the purpose of the ETL process. The identification of data that does not need to be transferred can be frustrated by the complexity of the structure for the source database as well as by the unknown content of the source data. Accordingly, embodiments of the present disclosure are directed toward generating a user interface that is designed to allow one or more individuals to select relevant data based upon actual values taken from the source database.

Various embodiments are directed toward an ETL tool that is configured to dynamically adapt to the actual content of a source database. This can be particularly useful for carrying out an ETL process without necessarily having an intimate understanding of the data structure (or layout) for the source database. Particular embodiments are directed toward the storage of an intermediate version of data being extracted. This storage is sometimes referred to as a “staging area,” which can be useful for correcting errors without necessarily requiring the raw data to be extracted a second time. Consistent with certain embodiments, the raw data in this storage area can be formatted according to a hierarchical structure. The formatted data can then be presented to a knowledgeable individual using user interface(s), which can be graphical or text based. The user interface can provide actual content values for selection, which allows for selections to be made based upon data characteristics that may not be previously known to the ETL tool (or its designer). The source data can then be filtered according to the selections made using the user interface.

Particular embodiments of the present disclosure are directed toward the use of the extract, transform and load (ETL) to transfer data across dissimilar systems, databases and applications. The dynamic filtering can be used in combination with other ETL techniques including, but not necessarily limited to, compression methodologies for transfer and structural filtering for data amalgamation. Aspects of the present disclosure recognize that rule-based filtering uses a pre-defined knowledge of the data structures. Moreover, the designers of the ETL processes may not understand the relevance (e.g., the business relationships) of the data content.

As a result, ETL processes have the potential of loading huge quantities of data often in excess of what is required for the business needs. Embodiments are therefore directed toward the integration of an interactive data content selection based on identification of keyed business elements. This content selection option can provide a mechanism to filter data, which can be used in combination with a (predetermined) rules-based approach. Such an approach can be particularly useful for generating filters or data organization designs that are based upon the primary business needs, reducing both processing time and physical storage in addition to mitigating the potential confusion of the end users.

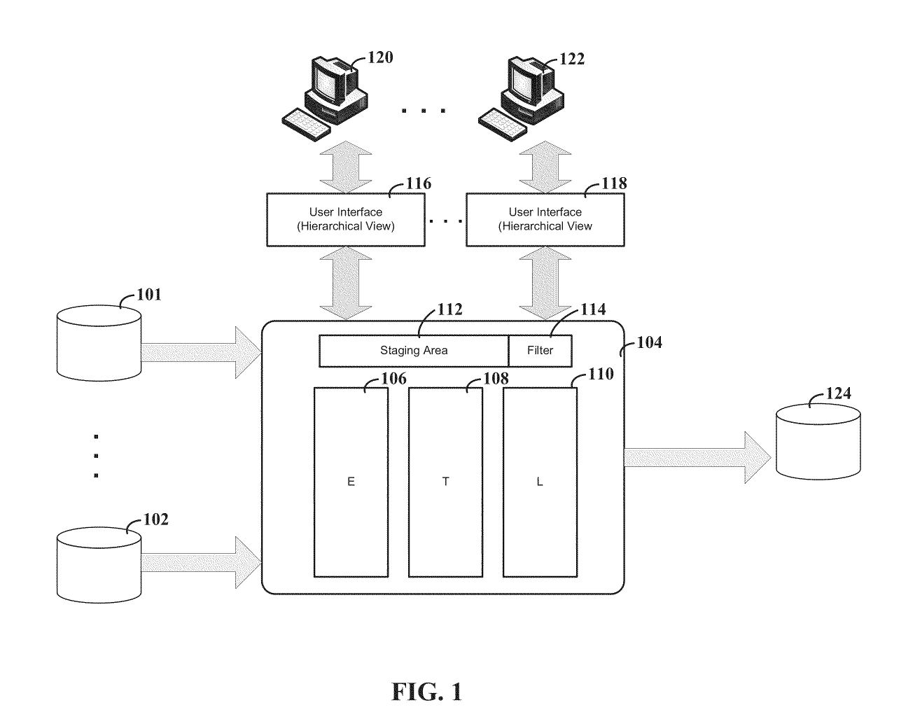

Turning now to the figures, FIG. 1 depicts a system diagram of modules useful in data transfer operations, consistent with embodiments of the present disclosure. The system of FIG. 1 can be configured to transfer data from one or more source databases 101, 102 to a destination or target database 124. A computer processing system 104 can be configured to perform extraction 106 (E), transformation 108 (T) and loading 110 (L) operations on the data from source databases 101, 102. As discussed herein, the computer processing system can include one or more computers each having one or more computer processor circuits, memory circuits and input/output (I/O) devices.

The computer processing system 104 can also be configured to store data extracted from the source databases 101, 102 in a temporary storage location or staging area 112. According to various embodiments, the data stored within the staging area 112 can be formatted to allow for classification of the objects and values that make up the stored data. For instance, the data can be formatted according to one or more hierarchical formats, which can be derived from associations between the objects and originating from the source databases 101, 102. Moreover, the formatting can allow for actual content values to be retrieved from the source databases 101, 102 and included into the hierarchical format.

Consistent with certain embodiments, the hierarchical formats can be used to generate one or more user interfaces 116, 118. These user interfaces 116, 118 can be sent to and displayed by remote devices (e.g., computers, tablets or handheld devices) 120, 122. The user interfaces 116, 118 can include selectable icons that correspond to the various objects within the hierarchical formats. Moreover, by including actual values retrieved from the source databases 101, 102, the users can be provided with the capability of selecting based upon content values that may or may not have been previously known to the computer processing system 104 and the system designers of the computer processing system 104.

In response to the selection of certain data objects or types of data, the computer processing system 104 can apply a filter 114 to the data stored in the staging area. Consistent with various embodiments discussed herein, the application of the filter can occur at different points during the data transfer process. This can result in a reduction in the amount of data processed, which can be particularly useful for reducing the processing time and complexity as well as for reducing the size of the destination database 124.

Consistent with certain embodiments, the user interfaces 116, 118 can each be configured based upon a respective and different target audience. For instance, one of the user interfaces can display a first set of information that is relevant to a first business unit, product, or other category. The second interface can display a second set of information that is relevant to a second business unit, product, or other category. Each of these interfaces can be routed to a respective individual or group of individuals.

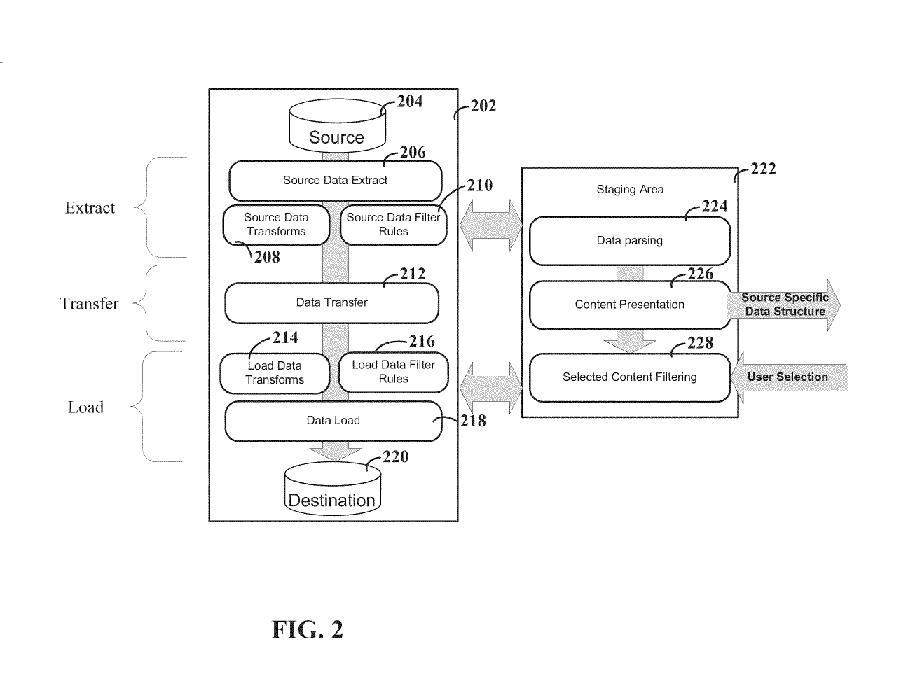

FIG. 2 depicts a flow diagram for transferring data between source and destination databases using dynamically constructed filters, consistent with embodiments of the present disclosure. Consistent with embodiments of the present disclosure and the various figures, block 202 can represent an ETL tool that controls the processing and the transfer of data between a source database 204 and a destination database 220. The processing flow can include aspects relating to ETL steps as applied to the data as it is moved from the source database 204 to the destination database 220.

For instance, the source data extract block 206 can obtain data from the source database 204. As discussed herein, the source database 204 can include a number of different databases and the extraction can therefore include extracting (and aggregating) data from multiple databases. According to certain embodiments, the extraction process can include a source transformation 208 of the extracted data, as shown by block 208. This transformation can, for instance, include modification of the data into a common format for use by the ETL tool 202 (e.g., for transportation or further transformation processing). The extraction process can also include filtering of the source data 210. For instance, the data can be filtered according to a set of predetermined rules in order to reduce the data quantity by removing data objects/content that is known to be unnecessary for the intended use of the destination database 220. The data can then be transferred 212 to the source database location where it can be transformed 214 and filtered 216 before loading 218 into the destination database 220.

As part of the ETL process, a copy of the extracted data can be stored in a staging area 222. This can be useful for allowing for recovery of data from an intermediate state should there be problems with the ETL process. For instance, if the loading process 218 fails for some reason, the data stored in the staging area 222 can be used to restart the process without carrying out another extraction process 206. Moreover, aspects of the present disclosure are directed toward the use of the data in the staging area 222 to allow one or more individuals to view the data and make decisions regarding which of the data should be loaded into the destination database 220.

The intermediate stage data from the staging area 222 can be parsed 224 according to the relationships between different data objects. For instance, the parsing 224 can identify field relationships between different data objects and parse the data accordingly. This parsing can include classification of data into different groups and linking data within the classifications to form a hierarchical data structure. Consistent with various embodiments, the parsing can maintain some or all of the hierarchical data structure of the source database 204.

The parsed data can then be presented 226 to an individual to allow them to select particular subsets of the data. This selection can be made using their personal knowledge of the data and its intended use relative to the destination database 220. For instance, the source database 204 could contain information about residential and commercial buildings. Part of this information may include image or Computer-aided Design (CAD) files, which often require a significant amount of data. The purpose of the ETL transfer to the destination may, however, be relevant to image files for particular types of buildings (or to image files at all). In some instances, the building types that are relevant may not be known to the designer of the ETL tool. This lack of knowledge might be caused by any number of reasons, such as the building types not being consistently identified in the source database 204 (e.g., where standardized terminology is not used to describe the building type). A person with knowledge of the particular business needs and contemplated use of the destination database 220 can view the actual content from the source database 204 and make an informed decision as to which building types to accept and exclude from the transfer.

The data in the staging area can then be filtered 228 in response to the user selections. Additional filtering is also possible, whether at this or another point in the ETL process. Embodiments of the present disclosure are directed toward the use of the staging area 222 and the associated parsing 224, display/selection 226 and filtering 228 at different points or stages of the ETL process. For instance, the particular point in the ETL process can be selected based upon where the ETL process would be restarted if there was a problem and the staging area data was to be used to avoid having to perform another extraction.

Embodiments are directed toward the use of distributed processing, such as by sending different portions of the data from the staging area 222 to different computers and different individuals for review and selection. The timing of when the interface is provided for use can also be determined based upon the availability of the reviewing individuals.

Particular embodiments are directed toward the use of an ETL data-process that utilizes a parse-able Extensible Markup Language (XML) data structure for the transfer of data. As discussed in more detail herein, the system can use a data-relationship definition for source-stage data content and hierarchical XML interpretation.

Various embodiments utilize structural information regarding the source data structure for the purpose of identifying and parsing the data fields related to the business content review within the staging area. For instance, the structural information can help to define the parsing requirements (e.g., parser type and record/field definitions). For an ETL that deals with large data files, a parser with record-by-record processing can be employed. In other instances, structural information can help identify the data fields useful for the particular business content review. For example, the structure information can include data elements that identify content classifications.

Consistent with various embodiments, the content classifications can sometimes have values that are not previously known and that can be interpreted by the selected individuals (e.g., business experts) for streamlining of the ETL process. For example, a complex data source may identify a “security group” field. If the content values are known prior to data transfer, a conditional data filter may be applied such as “security group=public”; however, if the values are dynamic in nature or unknown to the technical resources, a pre-defined filter may not be possible. For this case, the algorithm can be configured with prior knowledge sufficient to identify “security group” field for subsequent interpretation. The particular values (e.g., “public”) can be obtained from the actual data content of the source database(s).

According to embodiments, there may be multiple data fields selected and assigned to one or many classification schemes for business expert review and selection. Further data definitions may include whether or not the business data fields identified also have a data-related sort order.

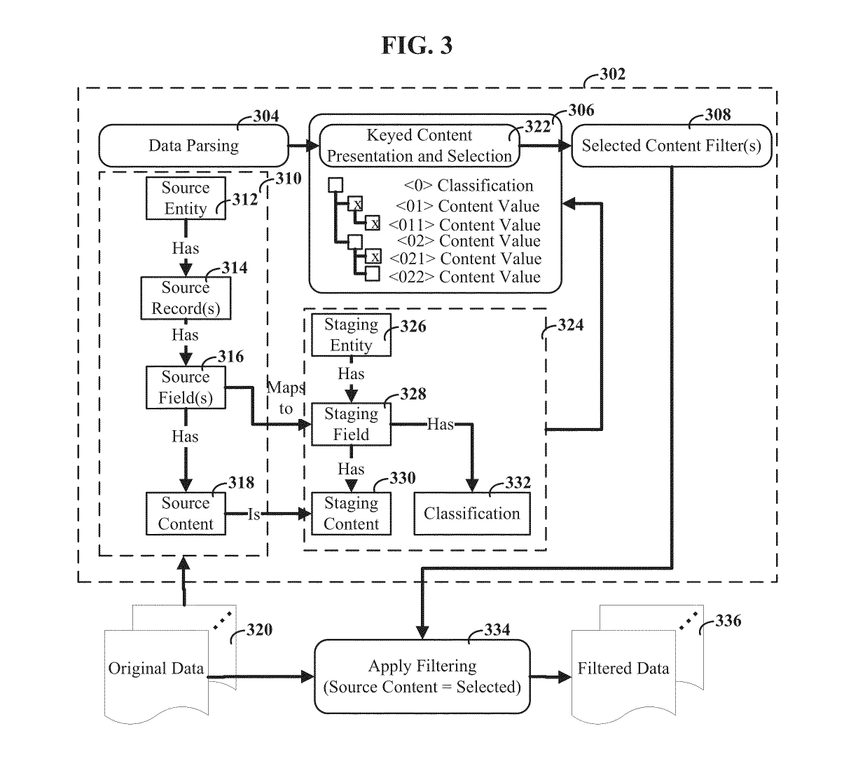

FIG. 3 depicts a flow diagram for a staging area and the configuration and display of content from a source database, consistent with embodiments of the present disclosure. The staging area 302 receives a copy of the raw/original data 320. Consistent with various embodiments, the raw/original data 320 can be obtained at a point after the extraction of an ETL process. A parsing module 304 can separate the raw data according to a hierarchical format, such as the format shown in 310. This format can include one or more source entities 312. The source entities 312 can each have one or more source records 314. In certain embodiments, the source records 314 of a source entity 312 can have a hierarchical relationship to one another. Each source record 314 can have one or more source fields 316. The source fields 316 can contain source data content 318.

For instance, the source entities might be defined consistent with the following pseudo code:

| SourceEntity | (0, 1 or many) | |
|---|---|---|
| \|--.Parser | identifies the path and executable to read the SourceEntity. | |
| \|--.ParserParameters | (as required to execute the parser) | |
| \| \|--.Order | order of parameters for executable | |
| \| ′--.Value | a pre-set value OR reference. | |
| ′--.SourceRecord | | |
| ′--.SourceField | (1 or many) | |
| \|--.Name | unique name for additional referencing. | |
| \|--.OnError | error level for a parsing error. One of: | |
| \| | IGNORE (continue as is), | |
| \| | SKIP (continue with blank field), | |
| \| | ERROR (continue to next record), | |
| \| | STOP (stop the load). | |
| \|--.Definition | | |
| \| \|--.Segment | (0, or 1) | <--------------------------------. |

| | | |
|---|---|---|
| \| \| \|--.Name | SegmentTag name | \| |
| \| \| \|--.Attribute | (0,1, or many) | \| |
| \| \| \| \|--.Name | --. required attribute name/value pairs. | \| |
| \| \| \| ′--.Value | --′ | \| |

| | | |
|---|---|---|
| \| \| ′--.Segment | (0,1) child segment | --------------------------′ |

| | |
|---|---|
| \| ′--.Tag | <Tag Attribute=Value> |
| \| \|--.Name | Tag name |
| \| ′--.Attribute | (0, 1, or many) |
| \| \|--.Name | --. required attribute name/value pairs |
| \| \|--.Value | --′ |
| \| ′--.UseValue | (true/false) if true .Content=.Attribute.Value |
| \|--.IsOrder | (true/false) this field interpreted as next parsed field order |
| | indicator. |
| ′--.Content | Data as parsed (unless .Segment.Tag.Attribute.UseValue=True) |

Consistent with various embodiments and the SourceEntity of the above pseudo code, the parser module can extract fields, which have been identified for data review selection based upon the definition in the Stage.Entity.StageField.MapFrom object elements, to the staging area. Those files that are not identified can be left out of the extraction process.

The identification of keyed business data fields allows for mapping of data content into one or more classifications for presentation. Considerations for this classification include, but are not necessarily limited to, each classification being uniquely generated with the data content and applying SourceEntity.SourceRecord.SourceField.IsOrder indicators. Hierarchical mapping may be maintained within each classification as per the identified/related SourceField fields. In order to maintain the flexibility for source content and required business selection, mapping of a SourceEntity.SourceRecord.SourceField to multiple classifications is possible. Similarly, multiple SourceEntity.SourceRecord.SourceFields may be mapped to single classifications.

Consistent with various embodiments, data definitions may allow for the use of default content (e.g., if SourceEntity.SourceRecord.SourceField.Name not found), override values (e.g., for identified SourceEntity.SourceRecord.SourceField.Name fields), presentation sorting (as found or by content, such as using an alphanumeric sort or by .SourceField.IsOrder.Content), business users being provided with edit capabilities (edit value, change order, etc.), default presentation selection on or off based on classification and keyed field and combinations thereof.

According to embodiments, the process can result in the generation of one or more classifications schemes based on the content of the source file. Following the example of a “security group” field, this could result in a display/selection such as:

(-)[ ]Security Group
|-- [ ] public
|-- [ ] internal
|-- [ ] secret
′-- [ ] top secret

In this case, the “<security group>” tag can be defined in the SourceField.Description, and the content within the source file can be classified by the content values (public, internal, secret and top secret). These content values can be provided for selection by the authorized/knowledgeable individual. Consistent with embodiments discussed herein, this selection list can be dynamically created and content driven. For instance, the values need not be known in advance and may also introduce new values (e.g. “need-to-know”) at any data transfer.

Consistent with certain embodiments, the algorithm can be designed to provide edit options (for example, the reviewing individual can change the content from “top secret” to “level 10 secrecy”), as well as default content assignment (for example, if the field is not found in the source database, the default value can be set to “top secret”).

Consistent with certain embodiments, the stage entities can be defined consistent with the following pseudo code:

| StageEntity | (0,1, or many) | |
|---|---|---|
| ′--StageField | (1 or many) | |
| \|--.MapFrom | a single SourceEntity.SourceRecord.SourceField.Name | <--. |
| \|--.Content | = SourceEntity.SourceRecord.SourceField.Content | \| |
| \| | where SourceEntity.SourceRecord.SourceField.Name = | --′ |

| | |
|---|---|
| ′--.Classification | (0, 1 or many) |
| \|--.Name | Classification (root) name. Omit from display if NULL. |
| \|--.Mode | DEFAULT: If SourceField.Contents is null, use .SetValue |
| \| | OVERRIDE: always use .SetValue |
| \|--.SetValue | Default or override value. |
| \|--.Lock | (true/false) If true, user may edit. Default false. |
| \|--.Order | One of: AS ENTERED (default) |
| \| | AS CONTENT (alphanumeric, or by |
| .SourceField.IsOrder) | |
| \|--.DefaultSelect | (true/false) sets the default presentation selection on or off |
| | (default) |
| ′--.MaintainHierarchy | (true/false) maintain any hierarchical structure for the .MapFrom |
| | tags under the defined classification. |

Consistent with certain embodiments, the staging area object can be defined consistent with the following pseudo code:

DataSelect

| | | |
|---|---|---|
| ′--.Classification | (0,1, many) all unique StageField.Classification.Name | <--. |
| \|--.Content | (1, many) all unique .StageField.Content | \| |
| \| | where .StageField.Classification.Name = | ---′ |

| | |
|---|---|
| \|--.Order | Derived from .StageField.Classification.Order |
| \|--.Level | Derived from .StageField.Classification.HasHierarchy |
| ′--.Selected | (true/false) User selected indicator. |

The various pseudo code and data structures provided herein are presented in terms of examples and are not meant to be limiting. Alternate structures may be used. For example, SourceEntity may be expanded to support non-XML formats—Delimited, Fixed—with the appropriate record and field parser.

Section 324 depicts a diagram representing relationships for a staging entity 326 that is constructed for use in connection with a user interface 306. In certain embodiments, the staging entity can be constructed using the parsing module 304. The staging entity 326 can include one or more staging fields 328, which can correspond to the source fields 316. The staging fields 328 can each have staging content 330, which can be directly retrieved from the source content 318. Staging fields 328 can also include one or more classifications 332.

The staging entities 326 can be used to present the data to knowledgeable individuals in a format that is simple to understand and that facilitates selection of data based upon actual content values from the original data 320. As shown in user interface 306 the content values can be presented in a hierarchical structure that includes selection options for different levels of the hierarchy. This can be particularly useful for providing keyed content presentation and selection 322 in a useful and efficient manner. Consistent with certain embodiments, the data parsing module 304 can be responsible for generating the user interface(s) 306. In various embodiments, separate modules can be used for the generation and display of the user interface(s) 306.

The selected content can then be used to create a data filter 308. Using a data filter module 334, this data filter 308 can be generated and applied to reduce the amount of data to the original data 320. The resulting filtered data 336 can then be provided back to the ETL process tool/module in order to complete the data transfer.

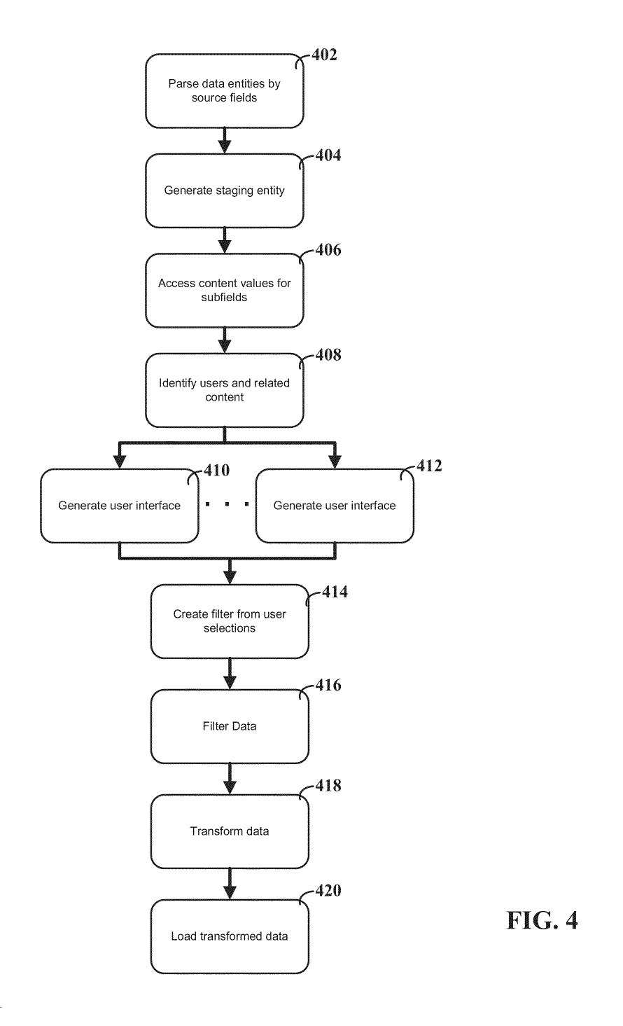

FIG. 4 depicts a flow diagram for carrying out a data transfer with dynamic selection of data content, consistent with embodiments of the present disclosure. As discussed herein, data can be extracted from one or more source databases. The data in the source databases can include data from a variety of different locations and respective databases, each of which can include different formats and structure for the data. Moreover, the data within the databases can change over time as the database is updated, added to or otherwise modified. At some point during the data processing step, the extracted data can be copied and stored in a staging area. In certain embodiments, the data in the staging area can be maintained for use should there be an issue with the transfer processing.

As shown in block 402, this extracted data in the staging area can be parsed according to the data structure. For instance, the data can be parsed according to the source fields associated therewith. The parsed data can then be used to generate a staging entity, as shown by block 404. As discussed herein, a staging entity can include a number of different subfields, with associated data content values. Consistent with embodiments of the present disclosure, the components of the staging entity can be arranged in a hierarchical structure. The particular content values can be taken directly from the extracted data, as shown by block 406. This can be particularly useful for allowing the staging entity to be constructed using data content values that are not known prior to the extraction and parsing.

At block 408, one or more individuals can be identified as candidates for reviewing the staging entities and their associated content values. Moreover, the identified candidates can be associated with different groups of the staging entities. For instance, an individual in a legal department may be associated with data relating to legal contracts, whereas an individual in a marketing department may be associated with data relating to advertisements or sales. There can be a number of different associations (e.g., matching products to business units).

One or more interfaces can then be generated for the identified candidates, as shown by blocks 410 and 412. Based upon feedback from the identified candidates (received from the interfaces), one or more filters can be created 414 and then applied 416 to the extracted data. The filtered data can then be transformed 418 and loaded 420 into the target/destination database.

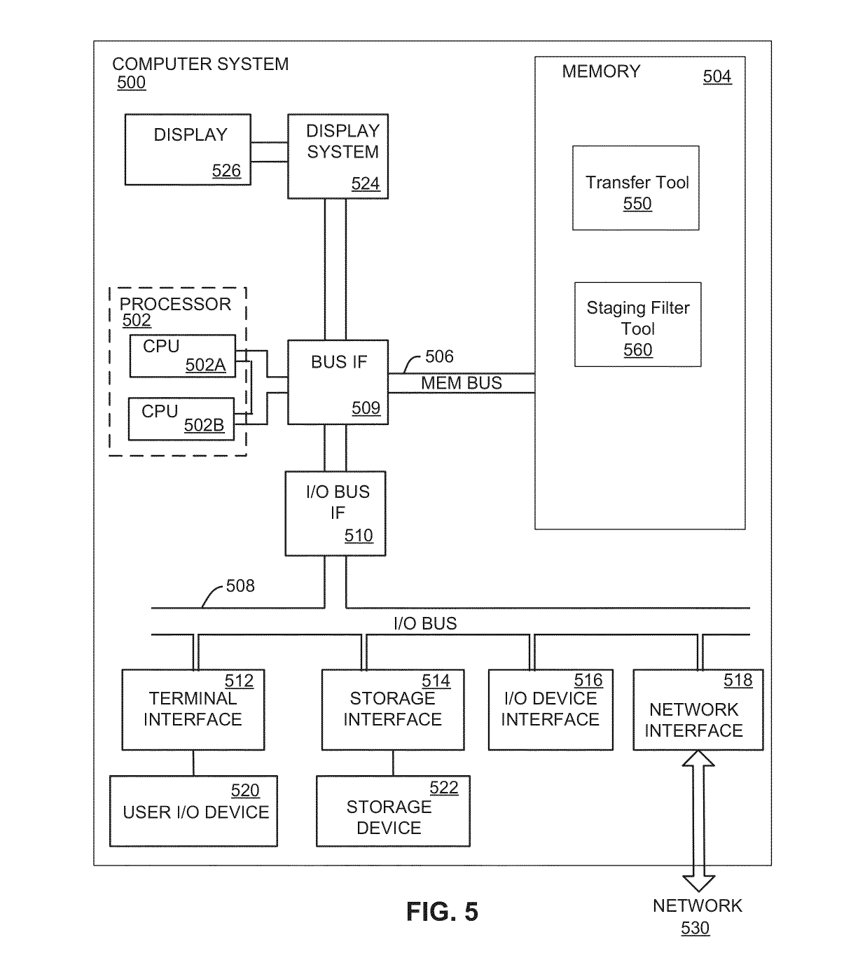

FIG. 5 depicts a high-level block diagram of an exemplary computer system 500 for implementing various embodiments. The mechanisms and apparatus of the various embodiments disclosed herein apply equally to any appropriate computing system. The major components of the computer system 500 include one or more processors 502, a memory 504, a terminal interface 512, a storage interface 514, an I/O (Input/Output) device interface 516, and a network interface 518, all of which are communicatively coupled, directly or indirectly, for inter-component communication via a memory bus 506, an I/O bus 508, bus interface unit 509, and an I/O bus interface unit 510.

The computer system 500 may contain one or more general-purpose programmable central processing units (CPUs) 502A and 502B, herein generically referred to as the processor 502. In embodiments, the computer system 500 may contain multiple processors; however, in certain embodiments, the computer system 500 may alternatively be a single CPU system. Each processor 502 executes instructions stored in the memory 504 and may include one or more levels of on-board cache.

In embodiments, the memory 504 may include a random-access semiconductor memory, storage device, or storage medium (either volatile or non-volatile) for storing or encoding data and programs. In certain embodiments, the memory 504 represents the entire virtual memory of the computer system 500, and may also include the virtual memory of other computer systems coupled to the computer system 500 or connected via a network. The memory 504 can be conceptually viewed as a single monolithic entity, but in other embodiments the memory 504 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 504 may store all or a portion of the various programs, modules and data structures for processing data transfers as discussed herein. For instance, the memory 504 can store a transfer tool 550 and/or a staging filter tool 560. These programs and data structures are illustrated as being included within the memory 504 in the computer system 500, however, in other embodiments, some or all of them may be on different computer systems and may be accessed remotely, e.g., via a network. The computer system 500 may use virtual addressing mechanisms that allow the programs of the computer system 500 to behave as if they only have access to a large, single storage entity instead of access to multiple, smaller storage entities. Thus, while the transfer tool 550 and the staging filter tool 560 are illustrated as being included within the memory 504, these components are not necessarily all completely contained in the same storage device at the same time. Further, although the transfer tool 550 and the staging filter tool 560 are illustrated as being separate entities, in other embodiments some of them, portions of some of them, or all of them may be packaged together.

In embodiments, the transfer tool 550 and the staging filter tool 560 may include instructions or statements that execute on the processor 502 or instructions or statements that are interpreted by instructions or statements that execute on the processor 502 to carry out the functions as further described below. In certain embodiments, the transfer tool 550 and the staging filter tool 560 are implemented in hardware via semiconductor devices, chips, logical gates, circuits, circuit cards, and/or other physical hardware devices in lieu of, or in addition to, a processor-based system. In embodiments, the transfer tool 550 and the staging filter tool 560 may include data in addition to instructions or statements.

The computer system 500 may include a bus interface unit 509 to handle communications among the processor 502, the memory 504, a display system 524, and the I/O bus interface unit 510. The I/O bus interface unit 510 may be coupled with the I/O bus 508 for transferring data to and from the various I/O units. The I/O bus interface unit 510 communicates with multiple I/O interface units 512, 514, 516, and 518, which are also known as I/O processors (IOPs) or I/O adapters (IOAs), through the I/O bus 508. The display system 524 may include a display controller, a display memory, or both. The display controller may provide video, audio, or both types of data to a display device 526. The display memory may be a dedicated memory for buffering video data. The display system 524 may be coupled with a display device 526, such as a standalone display screen, computer monitor, television, or a tablet or handheld device display. In one embodiment, the display device 526 may include one or more speakers for rendering audio. Alternatively, one or more speakers for rendering audio may be coupled with an I/O interface unit. In alternate embodiments, one or more of the functions provided by the display system 524 may be on board an integrated circuit that also includes the processor 502. In addition, one or more of the functions provided by the bus interface unit 509 may be on board an integrated circuit that also includes the processor 502.

The I/O interface units support communication with a variety of storage and I/O devices. For example, the terminal interface unit 512 supports the attachment of one or more user I/O devices 520, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 520 and the computer system 500, and may receive output data via the user output devices. For example, a user interface may be presented via the user I/O device 520, such as displayed on a display device, played via a speaker, or printed via a printer.

The storage interface 514 supports the attachment of one or more disk drives or direct access storage devices 522 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 522 may be implemented via any type of secondary storage device. The contents of the memory 504, or any portion thereof, may be stored to and retrieved from the storage device 522 as needed. The I/O device interface 516 provides an interface to any of various other I/O devices or devices of other types, such as printers or fax machines. The network interface 518 provides one or more communication paths from the computer system 500 to other digital devices and computer systems; these communication paths may include, e.g., one or more networks 530.

Although the computer system 500 shown in FIG. 5 illustrates a particular bus structure providing a direct communication path among the processors 502, the memory 504, the bus interface 509, the display system 524, and the I/O bus interface unit 510, in alternative embodiments the computer system 500 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 510 and the I/O bus 508 are shown as single respective units, the computer system 500 may, in fact, contain multiple I/O bus interface units 510 and/or multiple I/O buses 508. While multiple I/O interface units are shown, which separate the I/O bus 508 from various communications paths running to the various I/O devices, in other embodiments, some or all of the I/O devices are connected directly to one or more system I/O buses.

In various embodiments, the computer system 500 is a multi-user mainframe computer system, a single-user system, or a server computer or similar device that has little or no direct user interface, but receives requests from other computer systems (clients). In other embodiments, the computer system 500 may be implemented as a desktop computer, portable computer, laptop or notebook computer, tablet computer, pocket computer, telephone, smart phone, or any other suitable type of electronic device.

FIG. 5 is intended to depict the representative major components of the computer system 500. Individual components, however, may have greater complexity than represented in FIG. 5, components other than or in addition to those shown in FIG. 5 may be present, and the number, type, and configuration of such components may vary. Several particular examples of additional complexity or additional variations are disclosed herein; these are by way of example only and are not necessarily the only such variations. The various program components illustrated in FIG. 5 may be implemented, in various embodiments, in a number of different manners, including using various computer applications, routines, components, programs, objects, modules, data structures, etc., which may be referred to herein as “software,” “computer programs,” or simply “programs.”

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the present disclosure has been described in terms of specific embodiments, it is anticipated that alterations and modifications thereof will become apparent to those skilled in the art. Therefore, it is intended that the following claims be interpreted as covering all such alterations and modifications as fall within the true spirit and scope of the disclosure.

What is claimed is:

1. A computer-implemented method for transferring data from a source database configured with a first, hierarchical data structure to a destination database configured with a second, different data structure, the method comprising:
parsing the data from the source database according to a plurality of source fields that define a portion of the first, hierarchical data structure;
accessing content values stored in the source database for one or more subfields of the plurality of source fields;
generating a user interface that displays the content values in a selectable format;
creating a filter that is responsive to a selection of one or more of the content values displayed by the user interface;
filtering the data from the source database using the filter;
transforming the data from the source database according to the second, different structure of the destination database; and
loading the filtered and transformed data from the source database to the destination database.

2. The method of claim 1, wherein the hierarchical structure of the source database is an Extensible Markup Language (XML) format having child elements corresponding to the one or more of the plurality of subfields of the plurality of source fields.

3. The method of claim 2, wherein the content values are attribute values consistent with the XML format.

4. The method of claim 1, wherein the user interface includes multiple versions, each version displaying different content values.

5. The method of claim 4, further comprising providing the different versions of the user interface to different individuals.

6. The method of claim 4, wherein the different content values are selected, for each version, based upon associations between the content values and individuals identified for viewing a version of the user interface.

7. The method of claim 1, further comprising generating a plurality of staging entities from the parsed data from the source database, the plurality of staging entities including a hierarchical set of subfields for the parsed data.

8. The method of claim 7, wherein the plurality of staging entities each includes a lock value and further including providing, in response to a corresponding lock value, an option to edit a staging entity of the plurality of staging entities.

9. The method of claim 1, further comprising generating a staging area object that identifies certain data according to a classification and that includes a value indicating whether or not the data was selected using the user interface.

10. A device comprising:
a computer system designed to transfer data from a source database configured with a first, hierarchical data structure to a destination database configured with a second, different data structure, the system including
a parsing module configured to
parse data from the source database according to a plurality of source fields that define a portion of the hierarchical data structure,
access content values stored in the source database for one or more subfields of the plurality of source fields, and
generate a user interface that displays the content values in a selectable format;
a filter module configured to
create a filter that is responsive a selection of one or more of the content values displayed by the user interface, and
apply a filter module to filter the data from the source database using the filter; and
a transfer tool configured to
transform the data from the source database according to the second, different structure of the destination database; and
load the filter and transformed data from the source database to the destination database.

11. The device of claim 10, wherein the hierarchical structure of the source database is an Extensible Markup Language (XML) format having child elements corresponding to the one or more of the subfields of the plurality of source fields.

12. The device of claim 10, wherein the content values are attribute values consistent with the XML format.

13. The device of claim 10, wherein the user interface includes multiple versions, each version displaying different content values.

14. The device of claim 13, wherein the parsing module is further configured to provide the different versions of the user interface to different individuals.

15. The device of claim 13, wherein the different content values are selected, for each version, based upon associations between the content values and individuals identified for viewing a version of the user interface.

16. The method of claim 10, wherein the parsing module is further configured to generate a plurality of staging entities from the parsed data from the source database, the plurality of staging entities including a hierarchical set of subfields for the parsed data.

17. A computer program product for transferring data from a source database configured with a first, hierarchical data structure to a destination database configured with a second, different data structure, the computer program product comprising a computer readable storage medium having program code embodied therewith, the program code readable/executable by a computer processor to perform a method comprising:
parsing data from the source database according to a plurality of source fields that define a portion of the hierarchical data structure;
accessing content values stored in the source database for one or more subfields of the plurality of source fields;
generating a user interface that displays the content values in a selectable format;
creating a filter that is responsive a selection of one or more of the content values displayed by the user interface;
filtering the data from the source database using the filter;
transforming the data from the source database according to the second, different structure of the destination database; and
loading the filter and transformed data from the source database to the destination database.
